(19) United States
(12) Patent Application Publication
(10) Pub. No.: US 2009/0081333 A1
(43) Pub. Date: Mar. 26, 2009

(54) TEA INFUSER AND BLENDER

(76) Inventor: George Chizinsky, Beverly, MA (US)

Correspondence Address: ANTOINETTE G. GIUGLIANO, P.C.;DBA AGG Intellectual Property Law, 100 Cummings Center, Suite 454C, Beverly, MA, 01915, US

(21) Appl. No.: 12/053,606

(22) Filed: Mar. 23, 2008

Related U.S. Application Data
(60) Provisional application No. 60/994,821, filed on Sep. 24, 2007.

(51) Int. Cl. A47G 19/16; A47J 31/18

(52) U.S. Cl. 426/79; 99/323

(57) ABSTRACT

The present invention relates to a device for blending or infusing tea. The device has a shaft having an elongated portion, a loose tea compartment and a tea bag compartment. The loose tea compartment is positioned at a point along the elongated portion of the shaft, and includes a housing that has at least one surface with a plurality of perforations, and a reclosable door. The tea bag compartment is also positioned at a point along the elongated portion of the shaft, and embodies a housing that has a reclosable door, a retainer to hold one or more tea bags in place, and an opening. The present invention further includes systems and methods that utilize the device.

### RELATED APPLICATION

This application claims the benefit of U.S. Provisional Application No. 60/994,821, filed Sep. 24, 2007, entitled “Tea infuser/blender” by George Chizinsky.

The entire teachings of the above application are incorporated herein by reference.

### BACKGROUND OF THE INVENTION

Loose tea has generally been brewed using mesh strainers, mesh ball infuser, or a meshed hinged double-sided spoon. These devices are used to allow the tea to be infused into the surrounding water, but largely prevent the tea leaves from escaping and settling into the tea cup.

Tea bags are widely used, and tend to be a more convenient brewing method than using loose tea. However, tea bags are often more expensive than loose tea and/or are not available in as many varieties as loose tea.

Additionally, healthy or herbal teas exist, but several do not have a pleasant taste according to certain people. For example, it has been reported that green tea is rich in compounds that lower the risks of heart disease, cancer and other health problems. However, some people who drink green tea for health reasons have an aversion to its taste. In such a case, one may want to blend a healthful, but adverse tasting tea with a more pleasant tasting tea.

Hence, a need exists for a device that allows one to blend loose tea and/or tea bags simultaneously and conveniently. A further need exists to blend a tea type (e.g., loose tea or tea bag) that has an adverse taste (e.g., a herbal tea) with another tea type that has a more pleasant taste.

### SUMMARY OF THE INVENTION

The present invention relates to a device for blending or infusing tea into surrounding water. The device includes a shaft having an elongated portion, a top end and a bottom end; a loose tea compartment positioned at a point along the elongated portion of the shaft, the loose tea compartment comprises a housing that has at least one surface with a plurality of perforations, and a reclosable door. The device further encompasses a tea bag compartment positioned at a point along the elongated portion of the shaft, the tea bag compartment comprises a housing that has a reclosable door, a retainer to hold one or more tea bags in place, and an opening. The perforations of the loose tea compartment have a diameter through which loose tea is essentially prevented from passing. The shaft, in an embodiment, can be a rod or bar. The shaft further includes a base at the bottom end, wherein the base wherein the base acts as a stand. The shaft further has, in an instance, a handle at the top end. In an embodiment, the loose tea compartment and the tea bag compartment each include a front surface and a rear surface. A plurality of perforations of the loose tea compartment can be found at one or more surfaces (e.g., the front surface) of the loose tea compartment, including the sides of the compartment. The opening of the tea bag compartment, in an embodiment, is at the front surface of the tea bag compartment, but can be present on any surface of the compartment. The door of the compartments can be attached to the compartment e.g, with a hinge. In one embodiment, the door further includes a closure that allows the door to be opened and re-closed.

In another aspect of the invention, the device for blending or infusing tea includes a shaft having an elongated portion, a top end and a bottom end; one or more loose tea compartments, as described herein; one or more tea bag compartments, also as described herein, or any combination of both types of compartments. In an embodiment, the compartments are detachable from the shaft.

In yet another aspect, the present invention includes a device for blending or infusing tea. The device relates to a shaft having an elongated portion, a top end and a bottom end; a loose tea compartment, as described herein, and a tea bag retainer attached to the shaft or to a surface of the device. The tea bag compartment includes, in a particular embodiment, a housing, the tea bag retainer and an opening.

The present invention further pertains to a system for blending or infusing tea. The system encompasses a shaft, as described herein, and one or more compartments, also as described herein. The system, in an aspect, includes a handle attached to the top end of the shaft, a base attached to the bottom end of the shaft or both.

Embodied by the present invention are methods for blending loose tea and tea from a tea bag. The method includes placing the device, described herein, in heated water, wherein the loose tea compartment has loose tea, and the tea bag compartment has one or more tea bags, and the tea is infused into the water. The device is placed into the water for a period of time suitable for tea infusion (e.g., between about 30 seconds and about 5 minutes). The methods also include, in an embodiment, rotating (e.g., stirring) the device using the shaft. In another aspect, the methods further relate to adding one or more ingredients to the water, wherein the ingredients include sugar, cream, milk, lemon, honey or a combination thereof. The methods can also include placing loose tea into the loose tea compartment, or placing one or more tea bags into the tea bag compartment. The method further pertains to, for example, heating the water to a temperature between about 170° F. and 220° F.

The present invention has numerous advantages. The tea infuser/blender of the present invention allows for the user to easily utilize a combination of tea bags and loose tea at the same time. Additionally, the present invention allows blending of various types of teas to suit individual tastes. In particular, the present invention allows one to mix health-related, but adverse tasting tea (e.g., green tea or other herbal teas) with that of a tasteful tea. The user of the present invention can achieve rapid and thorough infusion of flavor from tea bags into the water because the tea bags are fully immersed in the water instead of floating on the surface as is currently the practice. The transfer of flavor can also be enhanced by rotating the device in one direction and another a few times to cause tea from the tea bag to infuse into the water. The steeping method of the present invention is more convenient for achieving flavor transfer than methods sometimes used to squeeze tea from the tea bag before discarding the used tea bag. The device of the present invention further allows the user to mix tea with other ingredients (e.g., sweetener, milk) by rotating the device, without the need for a spoon or an additional stirrer.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of the tea infuser and blending device of the present invention.

FIG. 2 is a front view of the device of the present invention showing the front side of the loose tea compartment.

FIG. 3 is a back view of the device of the present invention showing the front side of the tea bag compartment.

FIG. 4 is a side view of the device of the present invention.

FIG. 5 is the view of the other side of the device of the present invention.

FIG. 6 is a bottom view of the device of the present invention.

FIG. 7 is a top view of the device of the present invention.

### DETAILED DESCRIPTION OF THE INVENTION

A description of preferred embodiments of the invention follows.

The present invention relates to a device for blending or infusing tea, referred to herein as a “tea blender” and/or “tea infuser.” The tea blending/infusing device has a shaft to which at least one compartment, and preferably two or more compartments, are attached. The shaft is, in part, an elongated member having one or more of these compartments. One compartment type is a loose tea compartment, and the other is a tea bag compartment. In an embodiment, both compartment types are attached to the shaft so that the user can blend loose tea (e.g., such as green tea) with a tea bag (e.g., such as a black tea). Attaching the compartments to a shaft allows the user to more easily infuse the tea residing in the compartments into the surrounding hot water when the user rotates the device. Rotating the device back and forth causes a turbulent flow (e.g., a multi-dimensional flow) which more efficiently allows for the tea to be infused into the water, as compared to other methods.

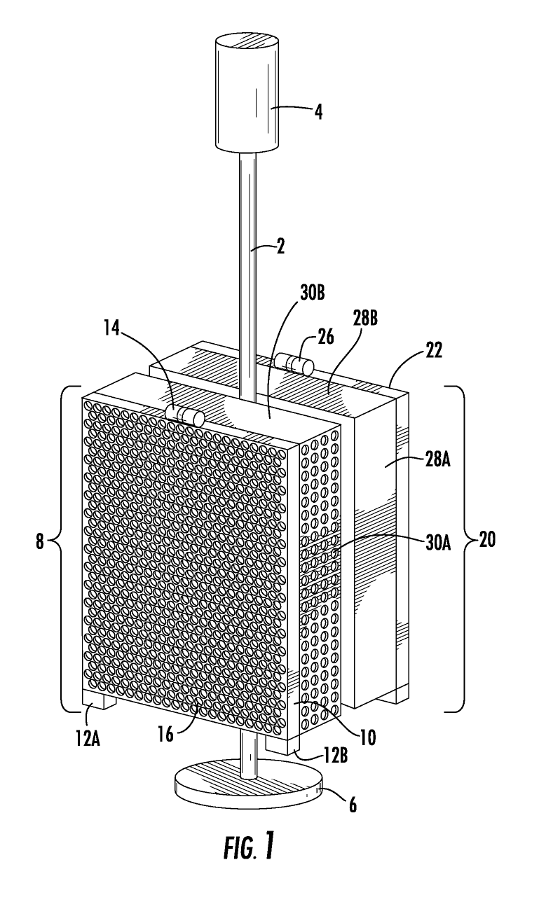

Referring to FIG. 1, tea blending device 40 has Loose Tea Compartment (LTC) 8 and Tea Bag Compartment (TBC) 20 attached to shaft 2. LTC 8 includes a rectangular housing into which loose tea is placed. The housing of LTC 8 has six sides that include a reclosable door, LTC door 10. The door is reclosable through the use of LTC snap closures 12A and 12B together with LTC hinge 14. LTC 8 is large enough to fit loose tea, but small enough to fit into a tea cup, mug, or beverage container. In one such embodiment, the tea blending device of the present invention has an overall width of between about 1 inch and about 6 inches (e.g., preferably about 2 inches and about 3 inches), and depth between about ½ and about 6 inches (e.g., preferably between about 1 and about 2 inches), and height between about 3 and about 8 inches (e.g., preferably between about 4 and about 6 inches). In a certain embodiment, the device measures about 2 inches in width, about 6 1/16 in height and about 1 1/16 in depth.

Accordingly, a LTC and/or TBC of the present invention, e.g., have a width of between about 1 inch and about 6 inches (e.g., preferably about 2 inches and about 3 inches), a height between about 1 inch and about 4 inches (e.g., preferably between about 2 inches and 3 inches), and depth of about ¼ inch and about 1½ inches (e.g., preferably between about ½). A specific embodiment includes a LTC and a TBC having a width of about 2 inches, a height of about 1½ inches, and a depth of about a ½ inch. In an embodiment, the LTC is large enough to receive 2 portions of loose tea.

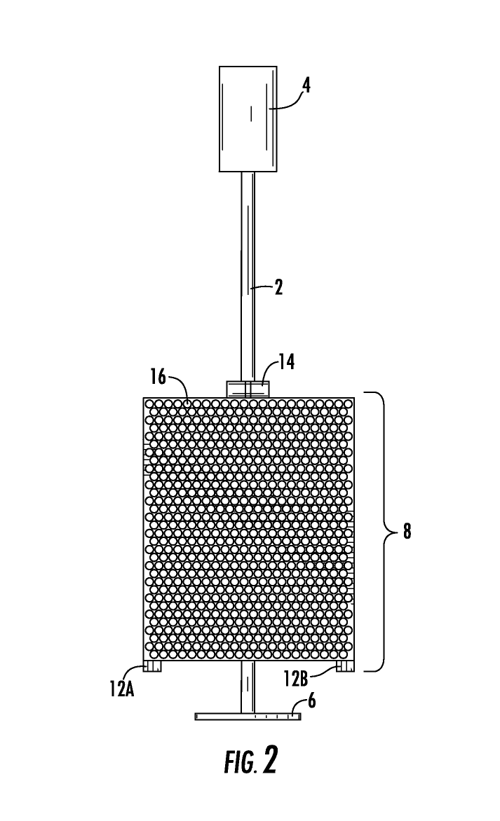

The LTC of the present invention has one or more sides or surfaces with a plurality of perforations. In the embodiment shown in FIGS. 1 and 2, LTC 8 has perforations 16 on door 10, and on two sides, LTC sides 30A and 30C. This embodiment has a total of three surfaces with perforations. The perforations can fully or partially cover one or more surfaces, and in an embodiment, the entire compartment can be covered with perforations. Perforations can exist on any side, partially or fully, of any compartment described herein. Perforations exist in quantity to sufficiently allow infusion of tea into the surrounding water, e.g., hot water. Additionally, each perforation has a size that is large enough for loose tea to infuse the surrounding water, but small enough to prevent significant amounts loose tea from passing through. In certain instances, small amounts of loose tea may pass through the perforations and settle on the bottom of the cup or mug. Infusion of tea refers to the transfer or osmosis of tea agents present on or in the tea leaves passing to the surrounding heated water. In an embodiment, the perforations have a diameter (e.g., pore size) ranging from about 0.01 inch to about 0.09 inch. Alternatively, perforations can be substituted with a porous membrane including a filter or mesh, through which heated water can pass and be infused with the tea agent. Examples of such a porous membrane include paper or nylon. Any porous membrane known in the art or later developed can be used so long as the tea can be infused into the surrounded heated water.

LTC door 10 forms a full side of LTC 8. A door also exists on the TBC. The tea blending device of present invention has a door that forms all or part of a compartment side. The door can be a hinge door (e.g., with use of hinge 14), as shown in the figure, or can be a slidable door, a retractable door, a bifold door, or any door type that allows for the loose tea or tea bag to be received by the respective compartment and re-closed. The door can be located at, or form a part of, any side or surface of the compartment. In the case in which a hinge is utilized, any hinge known in the art or later developed can be used. Additionally, the door can be part of more than one side of the compartment and, e.g., bends to help form the desired shape of the compartment. The doors of LTC 8 and TBC 20 of device 10 utilize snap closures 12A and 12B and snap closures 24A and 24B, respectively, to secure the door so that it remains closed during use. The user releases snap closures in order to open the door to remove and place loose tea or a tea bag into the compartment. Any closure device known or later developed can be used to allow the door of either the LTC or TBC to be reclosable. Examples of other closure devices include a spring, latch, pins, hooks, or lock/key mechanism.

LTC 8 or Tea Bag Compartment (TBC) 20 are shaped as a rectangular prism. However, the shape of the LTC, TBC or any other compartment can be pyramidal, cylindrical, cube, or any irregular three-dimensional shape or prism. In one example, each compartment forms ½ of a cylinder and when put together forms a complete cylinder. The shape of the LTC can complement the TBC and vice versa. Also, the shape of the LTC or TBC can be adapted to receive the shaft. The LTC and TBC can each have separate housings or form part of a single housing. In the latter case, the two or more compartments can be integrated or formed into a single compartment but separated, e.g., by a partial or full wall.

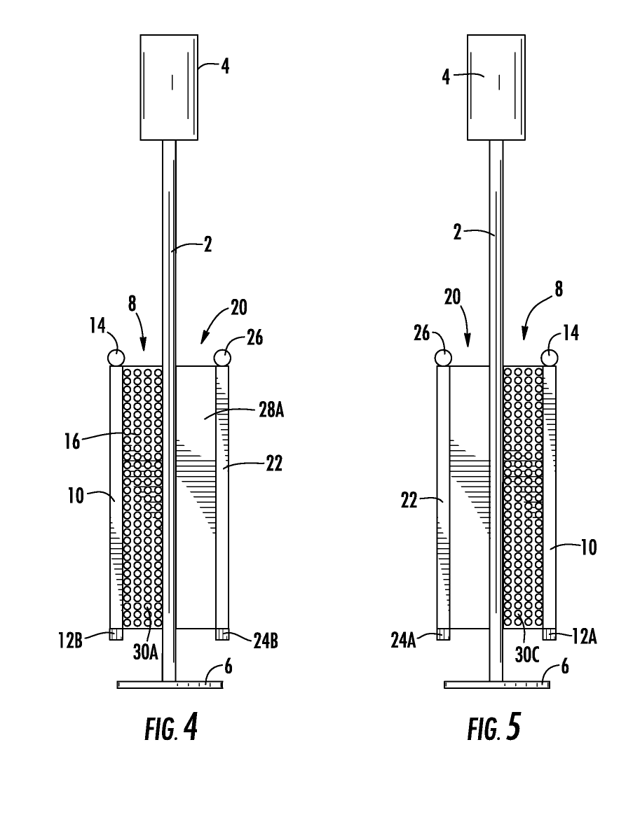

Shaft 2 shown in FIGS. 4 and 5 is welded to LTC 8 and TBC 20. The shaft has an elongated portion, a top end and a bottom end. The shaft of the present invention services, in an embodiment, can be rotated slightly in either direction to accelerate the transfer of flavor from the tea leaves to the heated water, as well as dissolve any added ingredients, such as milk or sweeteners. At any point along the elongated portion, the shaft can be welded, joined, fused, or soldered to the compartments, or otherwise attached to them. The shaft can be permanently attached, or temporarily attached (e.g., re-attachable). For example, the shaft can be glued with an adhesive that can withstand the water temperature, or tied to the compartments, e.g., using plastic ties. Additionally, the shaft can be clipped, snapped, tied, to the compartments, or be attached with a re-attachable device. Any device now known or later developed can be used to permanently or temporarily attach the compartments to the shaft. In one embodiment, the compartments are adapted to receive the shaft. For example, either compartment can include an opening or indentation in the compartment to receive or complement the shaft. More specifically, an opening can exist on top side 28B or 30B and a corresponding opening on bottom side 28D or 30D of TBC 20 or LTC 8, respectively, through which the shaft 2 is allowed to pass. In which case, the compartments can be welded to one another and a stopper can be placed on the shaft to prevent the compartments from sliding to base 6. Alternatively, the one or both compartments have an indentation that travels along the center interior side of each compartment to receive the shaft. The shaft can have a diameter ranging between about 1/32 inch to about a ½ inch. In an embodiment, the shaft is about 1/16 of an inch.

In the embodiment in which the compartments are re-attachable, the user can choose the type and number of compartments used. For example, the user can attach only the LTC, or two or more LTCs to blend two types of loose tea. Alternatively, the user can use only the TBC or two or more TBCs to blend two types of tea bags. In a preferred embodiment, the user utilizes the compartments as shown in the figures and can attach one LTC and one TBC.

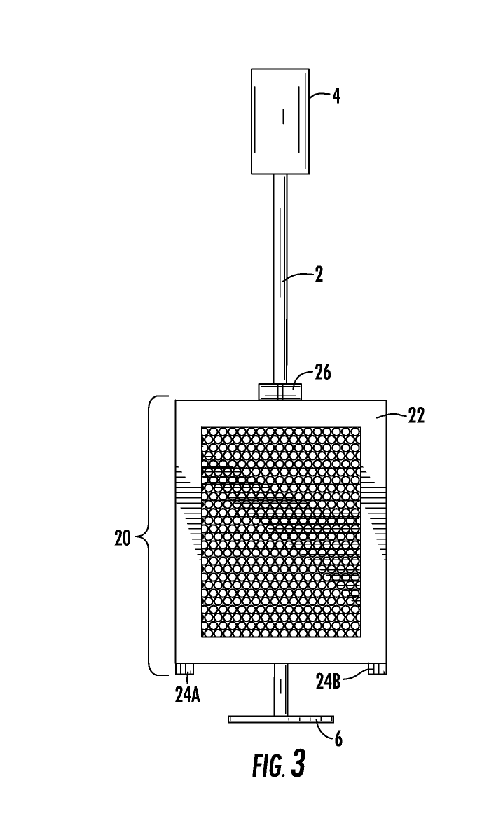

Referring to FIG. 3, the front view of TBC 20 is shown. TBC 20 has door 22 which is essentially a square frame or retainer that holds a tea bag in place. The interior wall (e.g., the side that is at the shaft) is perforated. In an embodiment, the interior side of both the TBC and the LTC are perforated, the door of the TBC is open and the door of the LTC has perforations. This design, for example, allows the water to more easily pass through both compartments and accordingly the blending of both teas because openings to allow for water to pass from an area of greater concentration to that of lesser concentration (e.g., osmosis) are provided. The opening on door 22 is optional, and its size can vary. The single opening can be replaced with perforations, in one instance. Alternatively or in addition to the single opening on the door, one or more opening can be placed on anyone or more of the sides of the TBC. The size of the opening created by the retainer's edges of the TBC is a size through which the tea bag is prevent from freely passing (e.g., easily passing without much resistance). The size of the opening can range between about a ½ inch and about 5½ inches, depending on the size of the compartment. The opening and hence the frame or retainer can be of any shape and can complement the shape of the TBC. In the figure, the retainer has 4 edges, however, the retainer of the present invention can have one or more edges so long as the retainer can hold one or more tea bags in place during use. In an embodiment the retainer has a width between about ⅛ of an inch to about 1 inch, and is preferably about ¼ of an inch. In the case of a single edge, the retainer can be a clip that compresses the tea bags against a wall of the compartment. In an embodiment, the TBC can be in the form of a single wall which, in an embodiment, can be shared with a LTC wall, having a retainer clip that holds one or more tea bags. The retainer, or any part of the device, in an embodiment, includes an artist design, logo, initials and/or symbol. Any wall used for the TBC can be shared with any wall of the LTC, and vice versa. As with LTC 8, TBC 20 also has a hinge, hinge 26, and snap closures, closures 24A and 24B. Also as with the LTC, the TBC or any compartment described herein, for example, has a width of between about 1 inch and about 6 inches (e.g., preferably about 2 inches and about 3 inches), a height between about 1 inch and about 4 inches (e.g., preferably between about 2 inches and 3 inches), and depth of about ¼ inch and about 1½ inches (e.g., preferably between about ½). The TBC is preferably large enough, in an embodiment, to receive at least two tea bags.

In FIGS. 4 and 5, side views of device 40 are shown. Shaft 2 is shown as an elongated cylindrical member with a top end and a bottom end. The top end has a cylindrical rotator knob handle, handle 4, and the bottom end has base 6. The shaft, in an embodiment, can be elongated but shaped to be a rod, bar, pyramidal, or cylindrical. The shaft can be any shape and the handle, shaft and/or base can be integrated or separate pieces that are attached, e.g., soldered or glued. In a certain embodiment, the device was made with a rotator knob to be used as a handle having a height of about 1 inch with a ½ inch diameter. In this embodiment, the compartments were positioned about 2 inches from the rotator knob. The length of the shaft including the handle ranges between about 4 inches and about 8 inches, and preferably about 6 inches.

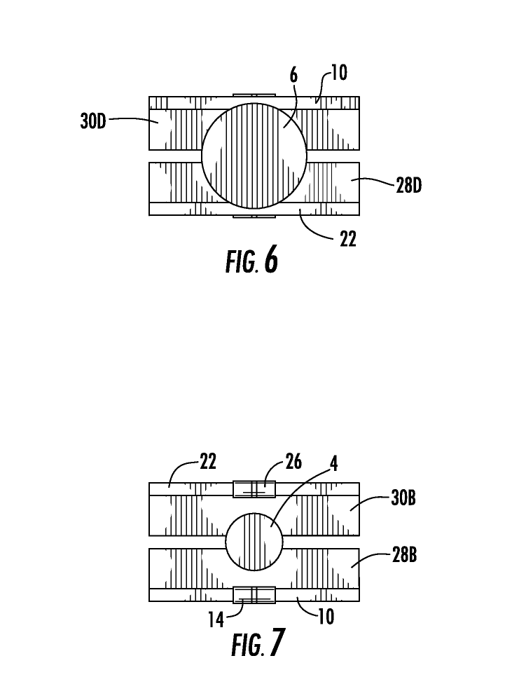

The base, attached to the bottom end of the shaft, is used to provide stability to the device and allow it to stand without assistance from the user. See FIG. 6. The base can be any shape including, e.g., circular. Additionally, the base (e.g., a stand) can be formed by one or more members, e.g., with feet. The base is optional in which case the device of the present invention would lean against the cup or mug when in use. In an embodiment, the base is a disc that measures between about a ½ inch to about 2 inches. In a specific case, the device was made with a circular disc having about a 1 inch diameter and about 1/16 thickness. To maintain balance in this embodiment, the compartments were positioned about ½ from the base.

Furthermore, while rotating the device, the base assists with mixing ingredients into the tea, e.g., sugar, cream, milk, lemon, honey and the like. The base is soldered to the shaft, but can be attached with an adhesive or any other methods known in the art. Also, the compartments can be attached or at the shaft along any point of the shaft. In a preferred embodiment, the compartments are situated closer to the bottom end of the shaft than the top end. Although the compartments can be attached (e.g., slidably attached) to the shaft, they are situated closer to the bottom end, in this instance, to keep the device balanced and from tipping. In the event that the compartments are closer to the top end, then the device can have a larger or heavier base to keep the device stable and preventing it from tipping.

At the top end of the shaft, handle 4 is attached, as shown in FIG. 7. The user utilizes the handle to rotate (e.g., stir) the tea mixture to facilitate tea blending or infusion, and/or mixing ingredients into the tea. Although the handle is cylindrical, it too can also be of any shape. In an embodiment, the handle can be ergonomically designed to receive a user's fingers, or has a tapered design similar to that of a spoon. The handle can be embossed to include logos, initials and other designs. The device can substitute the use of a spoon and blend the tea types and/or mix ingredients being used.

The device and any or all parts thereof can be made of any material that can withstand the hot water (e.g., a temperature of at least about 100° F., and preferably between 100° F. and 300° F., and more preferably between about 180° F. and about 220° F., e.g., boiling at about 212° F.). A preferred material is stainless steel, plastic, rubber, composite materials, paper, or any combination thereof. In yet another embodiment, the material is a disposable material or a recyclable material. The material can be any corrosion resistant metal such as silver or nickel. Also, the device can be made from other metals or materials and coated or plated with a corrosion resistant/proof material. In the case of stainless steel or other metal, the parts of the device can be soldered, attached or glued (e.g., with an adhesive) to one another. Additionally, the parts of the device can be designed to fit together or a mechanism can be used to keep them together, e.g., with screws, anchors, pins, snaps, clips, hooks, nuts, bolts, and fasteners.

In an embodiment, the present invention including its size can be adapted for a tea pot, and in which case, the device can be larger and shaped to fit into a tea pot. The device can fit through the opening and be placed therein before, during or after the water is heated. The device can have compartments for loose tea and/or tea bags, as described herein and include a handle. In an embodiment, the compartments can hang from the edge of the opening of the tea pot or from the tea pot cover. The device of the present invention can also be shaped to complement the tea pot, e.g., rounded.

As the described herein, the compartments (e.g., the LTC and/or TBC) are detachable and re-attachable, e.g., with a snap clip. As such, the device can have any combination of the compartments described herein. The device can utilize up to about 6 different compartments. For example, the device can be used with two LTC, and/or two TBC. One or more additional compartments can be utilized to add sweeteners (e.g., sugar, sugar substitutes, honey), a dairy product (e.g., milk or cream), or other flavors (e.g., lemon) into the tea blend. Often, the dairy product can come in the form of a powder for ease of use with the compartments. Such an additional ingredient compartment can have perforations or one or more openings, as described herein. In the situation in which the user wants the sweetener/dairy product to be infused into the water after the tea is infused, the compartment can have a sliding door or similar device that prevents the ingredient from being infused into the water until the user so desires. In the case of an additional compartment with a sliding door, the user can lift the door, e.g., with a slide bar attached to release the ingredient a few minutes after which the tea has had a chance to be infused into the surrounding hot water.

The present invention further includes methods of using the device of the present invention. The steps of the method include placing tea into one or more compartments of the device and placing the device into hot water for a period of time suitable for the tea to infuse into the surrounding water. In particular, the user can place loose tea into the LTC, a tea bag into the TBC, an ingredient into an ingredient compartment, or any combination thereof. In an embodiment, the water should be sufficiently hot enough to allow the tea to infuse into the surrounding heated water (e.g., a temperature of at least about 100° F., and preferably between 100° F. and 300° F., and more preferably between about 180° F. and about 220° F., e.g., boiling at about 212° F.). The time for infusion of tea into the surrounding water is dependent on several factors such as the type of tea, the amount of tea, the temperature of the water, and the like. Generally, at a temperature of between about 170° F. and 220° F., most teas can infuse for at least about 30 seconds to about 5 minutes, and preferably for about 2 minutes. In the case in which an additional ingredient compartment is being used to supply an ingredient such as sugar, dairy product or other flavoring to the tea, the ingredient can be release simultaneously or sequentially in time, as desired by the user. In the case in which the user wants to release the ingredient after the tea has been infused, then the methods include subsequently releasing the ingredient, e.g., by lifting a slidable door on the compartment. The user can further use the device to mix the tea and as such a step of the method can include rotating the device. The device, for instance, mixes or blends the tea by rotating the handle attached to the shaft. Rotating the device back and forth creates a turbulent flow (e.g., a multi-dimensional flow) which more efficiently allows for the tea to be infused/blended into the water. As such, the device of the present invention allows one to infuse or blend tea more efficiently (e.g., an increase in the amount of tea per unit of volume per unit of time), as compared to infusion without the device. The device can optionally be removed prior to drinking the tea. An advantage of the device is that the user does not need to squeeze a tea bag after use. The device along with any loose tea or used tea bag is simply lifted out of the mug and placed aside (e.g., in a tea saucer).

### Exemplification

The present invention shown in the figures was made using a rod with a knob located at the top of the rod, dual connecting chambers attached to the rod and a support plate (e.g., referred to herein as a “base”) at the bottom of the rod. The dual connecting chambers (e.g., referred to herein as “compartments”) are comprised of two sections: one section with perforated sides and a second section that has an open side but with retainer edges. Each section is equipped with a hinged list to close the section in order to contain the loose tea or tea bags. The dual connecting chambers are attached to the rod near the bottom of the rod to provide balance. The duel connecting chambers may be connected to the rod by a welded connection, but in this case an opening was placed through one of the chambers to receive the rod. The chambers were attached to one another using an adhesive. The knob used on the device was a rotator knob that provided a convenient means of holding the device with the fingertips in order to rotate the device briefly in either direction. The base at the bottom was a flat round disc (e.g., a coin) that was welded to the shaft and allowed the device to sit at the bottom of a tea cup and provide a convenient base for rotating the device in either direction.

The perforated chamber (e.g., loose tea compartment) that holds the loose tea is sized large enough to accommodate up to two portions of loose tea. Although the compartments can have various sizes, as described herein, the size of the loose tea and tea bag compartments were about 1¾ inches wide, 2⅛ inches tall and ½ wide. The diameter of the perforations was large enough to permit water to flow freely through the chamber without allowing tea leaves to escape from the chambers. The perforations had a diameter of between about 0.01 inch and about 0.09 inch. The tea bag chamber (tea bag compartment) was large enough to accommodate two tea bags. The lid for both chambers was hinged to close the section using a snap closure device. The rod, handle and base were made out of metal, and the chambers were made from hard plastic. The overall device measured about 6 inches tall, about 1¾ inches wide and about 1⅛ inches deep.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A device for blending or infusing tea into surrounding water, the device comprises:
a. a shaft having an elongated portion, a top end and a bottom end;
b. a loose tea compartment positioned at a point along the elongated portion of the shaft, the loose tea compartment comprises a housing that has at least one surface with a plurality of perforations, and a reclosable door; and
c. a tea bag compartment positioned at a point along the elongated portion of the shaft, the tea bag compartment comprises a housing that has a reclosable door, a retainer to hold one or more tea bags in place, and an opening.

2. The device of claim 1, wherein the perforations of the loose tea compartment have a diameter through which loose tea is essentially prevented from passing.

3. The device for blending or infusing tea of claim 1, wherein the shaft is a rod or bar.

4. The device for blending or infusing tea of claim 3, wherein the shaft further comprises a base at the bottom end.

5. The device for blending or infusing tea of claim 4, wherein the base wherein the base acts as a stand.

6. The device for blending or infusing tea of claim 5, wherein the shaft further includes a handle at the top end.

7. The device for blending or infusing tea of claim 1, wherein the loose tea compartment and the tea bag compartment each comprise a front surface and a rear surface.

8. The device for blending or infusing tea of claim 7, wherein the plurality of perforations of the loose tea compartment are at the front surface of the loose tea compartment.

9. The device of claim 8, wherein the loose tea compartment further includes a first side and a second side, each side includes a plurality of perforations.

10. The device of claim 7, wherein the opening of the tea bag compartment is at the front surface of the tea bag compartment.

11. The device of claim 1, wherein the door is attached to the compartment with a hinge.

12. The device of claim 1, wherein the door further includes a closure that allows the door to be opened and re-closed.

13. A device for blending or infusing tea, the device comprises:
a. a shaft having an elongated portion, a top end and a bottom end;
b. one or more compartments that include:
i. a loose tea compartment positioned at a point along the elongated portion of the shaft, the loose tea compartment comprises a housing that has at least one surface with a plurality of perforations, and a reclosable door;
ii. a tea bag compartment positioned at a point along the elongated portion of the shaft, the tea bag compartment comprises a housing that has a reclosable door, a retainer to hold one or more tea bags in place, and an opening, or
iii. both i and ii.

14. The device of claim 13, wherein one or more of the compartments are detachable from the shaft.

15. A device for blending or infusing tea, the device comprises:
a. a shaft having an elongated portion, a top end and a bottom end;
b. a loose tea compartment positioned at a point along the elongated portion of the shaft, the loose tea compartment comprises a housing that has at least one surface with a plurality of perforations, and a reclosable door; and
c. a tea bag retainer attached to the shaft or to a surface of the device.

16. The device of claim 15, further including a tea bag compartment that comprises a housing, the tea bag retainer and an opening.

17. A system for blending or infusing tea, the system comprises:
a. a shaft having an elongated portion, a top end and a bottom end;
b. one or more compartments that include:
i. a loose tea compartment positioned at a point along the elongated portion of the shaft, the loose tea compartment comprises a housing that has at least one surface with a plurality of perforations, and a reclosable door;
ii. a tea bag compartment positioned at a point along the elongated portion of the shaft, the tea bag compartment comprises a housing that has a reclosable door, a retainer to hold one or more tea bags in place, and an opening; or
iii. both i and ii.

18. The system of claim 17, further including a handle attached to the top end of the shaft, a base attached to the bottom end of the shaft or both.

19. A method for blending loose tea and tea from a tea bag, the method comprises:
placing a device in heated water, wherein the device comprises:
i. a shaft having an elongated portion, a top end and a bottom end;
ii. a loose tea compartment positioned at a point along the elongated portion of the shaft, the loose tea compartment comprises a housing that has at least one surface with a plurality of perforations, and a reclosable door; and
iii. a tea bag compartment positioned at a point along the elongated portion of the shaft, the tea bag compartment comprises a housing that has a reclosable door, a retainer to hold one or more tea bags in place, and an opening;
wherein the loose tea compartment has loose tea, and the tea bag compartment has one or more tea bags, and the tea is infused into the water.

20. The method of claim 19, further including rotating the device using the shaft.

21. The method of claim 20, further including adding one or more ingredients to the water, wherein the ingredients include sugar, cream, milk, lemon, honey or a combination thereof.

22. The method of claim 20, the method further includes placing loose tea into the loose tea compartment.

23. The method of claim 20, the method further includes placing one or more tea bags into the tea bag compartment.

24. The method of claim 20, heating the water to a temperature between about 170° F. and 220° F.
